(19) United States
(12) Patent Application Publication
(10) Pub. No.: US 2006/0149629 A1
(43) Pub. Date: Jul. 6, 2006

(54) System and method for promoting product sales

(75) Inventors: Wen-Guo Wang, Tien-Jin City (CN); Chia-Chun Lee, Taipei (TW); Jeff Song, Taipei (TW); Win-Ham Liu, Taipei (TW)

Correspondence Address: M. John Carson;FULBRIGHT & JAWORSKI L.L.P., 865 South Figueroa, Twenty-Ninth Floor, Los Angeles, CA, 90017-2571, US

(73) Assignee: INVENTEC CORPORATION

(21) Appl. No.: 11/096,324

(22) Filed: Mar. 30, 2005

(30) Foreign Application Priority Data
Dec. 31, 2004 (TW) 093141854

(51) Int. Cl. G06Q 30/00

(52) U.S. Cl. 705/14

(57) ABSTRACT

A system and method for promoting product sales are proposed and applicable to data processing devices, characterized in the use of a computing mechanism for calculating the unit profit of a main product according to sales-related information of the main product and a promotional product thereof; a judging mechanism for judging the appropriateness of the promotional content so as to come up with a reasonable scheme for the product promotion, and further provides related information of the promotional schemes for reference and selection. In addition, the sales-promoting system and method of the present invention further provides inquiry and checking of the promotional scheme.

### FIELD OF THE INVENTION

The present invention relates to a system and method for promoting product sales, and more particularly, to a system and a method applicable to a data processing device for promoting sales of products.

### BACKGROUND OF INVENTION

In order to be competitive, enterprises must strive to be efficient. To achieve greater development and marketing efficiency, enterprises focus on developing improved means for managing sales and distribution channels, consequently bringing about new product-flow distribution means and distribution management tools as a result of competition.

Conventional distribution modes of managing product-flow no longer satisfy market needs. Novel distribution methods utilizing electronic data processing devices or network communication systems have become indispensable to modern product marketing. Although an ever-growing trend exists to use electronic data processing devices or network communication systems to assist product-flow distribution management, current distribution management tools, including software or hardware available on the market, are still evolving. Moreover, drawbacks have gradually emerged in these systems that require solutions.

Brand marketers often use sales promotions as a means to promote product sales. For example, in order to promote the sales of a notebook computer, up-stream or down-stream distributors might choose to use a printer as a complimentary item bundled with the main product in order to stimulate consumer demand for the product. However, existing distribution systems are inherent with limitations in terms of their ability to manage and track product promotions. For instance: 1) Lack of scientific calculations for promotional items: early experience in promoting promotional items no longer meets the economic requirements as the existing distribution systems available on the market are mostly based on conventional modes of management, thereby lacking an effective method for evaluating the sales of products and providing reliable figures for promotions for business managers' reference. 2) Failure to adequately differentiate main products and promotional items: due to the restrictions of conventional manual operation, the existing electronic distribution systems adversely mix up main products with promotional items causing disparity between real warehouse and virtual electronic information, thereby increasing user difficulty. 3) Mismanagement of promotional schemes: confusion of real and virtual electronic information leads to vague tracking of main products and promotional items and hit-or-miss application of promotional schemes, such as unbalanced inventories of the main product and promotional items in storage and warehouses as well as the lack of an all-out scheme in promoting the sales of main products and promotional items. 4) Inappropriate or indefinite sales promotion objects/targets: prior art distribution systems fail to identify appropriate objects/targets for promoting the sales based on objective criteria, thus this lack of information leads to futile efforts exerted on the wrong targets, leading to failed sales promotions as a result. 5) Indefinite quantities for products assigned for sales promotion: due to the vague differentiation between the quantity of main products and promotional items, there is no common standard in promoting product sales which may adversely increase costs in the event of a poorly executed promotion. 6) Inaccurate or inappropriate timing for promoting sales: since timing is a crucial factor in the success of a sales promotion, the prior art promotional systems' lack of a mechanism for judging the right market timing results in a decrease in the profitability of sales promotions.

Therefore, it is critical to develop management tools which have the ability to effectively manage product promotions in order to optimize product sales.

### SUMMARY OF THE INVENTION

A primary objective of the present invention is to provide a system and a method for promoting product sales that can generate reasonable sales-promoting schemes based upon related sales information for the main products and promotional items.

Another objective of the present invention is to provide a system and a method for promoting product sales that is capable of managing main products and promotional products separately, so as to facilitate sales promotions involving a combination of a main product with one or more promotional products according to certain conditions.

Further objective of the present invention is to provide a system and a method for promoting product sales that is capable of choosing better market timing and that can select suitable candidate products for sales promotions.

Further another objective of the present invention is to provide a system and a method for promoting product sales that is capable of integrating various sales promoting activities and schemes for different distributors, thereby preventing sales promotion conflicts.

In accordance with the foregoing and other objectives, the present invention proposes a system for promoting product sales. The sales-promoting system comprises a data-accessing module for reading related product information for the main product and one or more associated promotional products; a computing module for generating reasonable promotional schemes based on the accessed product information relating to the main product and the promotional products according to a pre-determined profit-calculation basis; and a setting module for setting related promotional information comprising at least timing and targets for conducting promotional activities based on the promotional schemes. In one embodiment, the sales-promoting system of the present invention further comprises a judging module for use to check whether the promotional timings and targets have been completed. In another embodiment, the sales-promoting system of the present invention further comprises a checking module for use to estimate whether a specific main product should come with a particular promotional product in a promotional scheme.

The method for promoting product sales in the use of the sales-promoting system comprises the steps of: first, accessing related product information for the main product and the promotional product; next, calculating a reasonable promotional scheme according to the accessed product information and a predetermined profit-calculating basis; then, setting related promotional information comprising at least promotional timing and targets. In one embodiment, the sales-promoting method of the present invention further comprises a step of judging if the promotional timings and targets have been completed. In another embodiment, the sales-promoting method of the present invention further comprises a step of estimating whether a specific main product should come with a particular promotional product.

Compared to the promotional systems used in the prior art, the sales-promoting system and method of the present invention applicable to a data processing device are capable of calculating the unit profit of the main product according to the sales-related information of the main product and promotional product via a calculating mechanism. Further, the present invention is capable of generating effective promotional schemes via a judging mechanism to provide suitable promotional schemes for reference and selection. In addition, the present invention provides checking and assistance to help determine if a specific main product should come with one or more particular promotional products for the promotional scheme.

### BRIEF DESCRIPTION OF THE DRAWINGS

The present invention can be more fully understood by reading the following detailed description of the preferred embodiments, with reference made to the accompanying drawings wherein:

FIG. 1 is a schematic diagram showing the system configuration of a system for promoting product sales of the invention;

FIG. 2 is a schematic flow diagram showing the procedural steps necessary for executing a method for promoting product sales of the invention;

FIG. 3 is a schematic flow diagram showing the procedural steps involved in FIG. 2 for determining suitable promotional timings and targets; and

FIG. 4 is another schematic flow diagram showing the procedural steps performed in another preferred embodiment for judging if a specific main product should come with particular promotional products for a promotional scheme.

### DETAILED DESCRIPTION OF THE PREFERRED EMBODIMENT

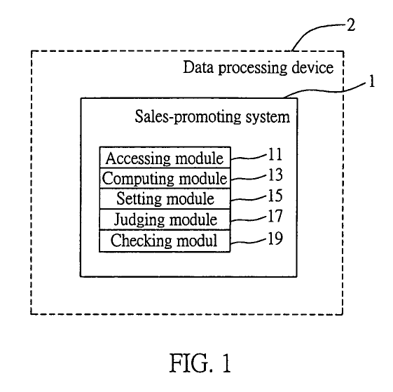

FIG. 1 illustrates the basic configuration of a system for promoting product sales of the invention. In this embodiment, the sales-promoting system 1 is applied to a data processing device 2, the data processing device 2 can be a workstation, a personal computer, a notebook computer, a palm computer or a personal digital assistant (PDA) having data processing capability. Preferably, the data processing device 2 further comprises a network communication function for allowing users to manage product promotional schemes at a terminal device via the network system. It should be noted that, in this embodiment, promotional items refer to complimentary gifts given away when purchasing a main selling product.

Additionally, in this embodiment the sales-promoting system 1 of the present invention at least includes an accessing module 11, a computing module 13, and a setting module 15.

The accessing module 11 is used to retrieve product information associated with the main products and the promotional products. In this embodiment, product information relating to main products includes product serial numbers, names, purchase prices, selling prices, units, stock, specifications, properties, contents, manufacturers and/or places of original production. Similarly, product information relating to promotional products may also include product serial numbers, names, purchase prices, selling prices, units, stock, specifications, properties, contents, manufacturers and/or places of original production.

In practice, the categorization of main products and promotional products is relative as opposed to absolute, which means that the same product can be assigned as a main product or as a promotional item depending on the situation to comply with varying practical needs. In addition, related information for the main and promotional products can be stored in a database (not shown) of the data processing device 2. Also, the database of this embodiment is an associative database that is designed to permit the accessing module 11 to access to all product information by reading only product serial numbers of the main and promotional products.

The computing module 13 is used to calculate reasonable promotional schemes based on the accessed product information and a pre-determined profit-calculating basis. In this embodiment, the profit-calculating basis includes following definitions:

Desired Profit: The Desired Profit is the profit desired by the seller for selling a product, which is subjectively determined based on conditions and actual operating situations, and can be input or altered when inputting the product information.

Unit Profit: Unit Profit=Unit Selling Price−Unit Purchase Price of the Main Product−Unit Purchase Price of the Promotional Product. That is, the Unit Profit is the potential profit gained per unit product sold for a particular promotional scheme.

Actual Profit Ratio: Actual Profit Ratio=Unit Profit/Desired Profit. This is a fluctuating ratio for the Unit Profit relative to the Desired Profit.

Floor Profit Ratio: The Floor Profit Ratio is set by the seller, which specifies a bottom limit for the Actual Profit Ratio. In other words, the Actual Profit Ratio must be greater than the Floor Profit Ratio.

For example, if the Desired Profit for selling a car is 5000 dollars, and the Floor Profit ratio is user-selected to be 60% (implying that the Unit Profit must not drop below 3000 dollars (5000×60%)), and the Unit Profit is calculated to be 4000 dollars under a certain promotional scheme, then the Actual Profit Ratio is 80% (4000/5000), which is higher than the preset Floor Profit Ratio of 60%, meaning that the promotion scheme for this product is a reasonable scheme. As mentioned earlier, the Floor Profit Ratio is to be input or altered when inputting the product information, and is judged subjectively according to the conditions and based on actual operations. On the other hand, in this embodiment, the Unit Profit is calculated and obtained from the price difference of the Selling Price of a Main Product and the sum of the Purchase Price of the Main Product and the Purchase Price of a plurality of N Promotional Products. In this embodiment, N is an integer variable greater than or equal to 1 (N≧1), meaning it can be adjusted by adding or deducting one whole unit at a time providing that its value is 1 or greater. For example, in the case of a computer being sold with a single printer (N=1) as a promotional item, the profit from the sales of the computer equals the sales price of the computer minus the purchase price of the computer minus the purchase price of the printer.

As described above in the embodiment, when choosing a computer as a main selling product and a printer as a promotional item, the computing module 13 calculates the Unit Profit for the computer according to the aforementioned calculating basis. Then, it compares the Actual Profit Ratio (Unit Profit divided by the Desired Profit) with the Floor Profit Ratio (user determined) to see if the Actual Profit Ratio is larger than the Floor Profit Ratio. As mentioned above, the quantity of the printer used as a promotional item can be variably selected by starting from a value of 1 and successively adding 1 each time until the Actual Profit Ratio falls to or below the Floor Profit Ratio, at which time the calculated outcome would no longer be considered a good value for a reasonable promotional scheme.

The setting module 15 is used to set related promotional information at least comprising the names, times, areas and/or targets for promotional schemes. As described above in the embodiment, if the computing module 13 determines that the Actual Profit Ratio is larger than the Floor Profit Ratio, then the setting module 15 proceeds to display the content of the promotional scheme and store the same in the database thereof. Further, the setting module further provides an input function for related information at least comprising the names, times, areas and/or targets for promotional schemes.

In another preferred embodiment of the present invention, the sales-promoting system 1 further comprises a judging module 17 for use to verify if the settings of related promotional timing and targets have been completed. In this preferred embodiment, the accessing module 11 is used to retrieve from the database thereof the related product information of the main and promotional products and the contents of the promotional schemes thereof. Subsequently, the judging module 17 verifies if the retrieved promotional scheme actually corresponds to the setting information comprising the promotional names, time, areas and/or targets. The setting module 15 proceeds to set any conditions should there be a condition missing.

In another preferred embodiment of the present invention, the sales-promoting system 1 further comprises a checking module 19 for use to determine if a specific main product should come with a promotional gift. To provide correct information for promotional schemes particularly in receipt of an order, the accessing module 11 is used to further retrieve from the database thereof information for the content of an order, the corresponding main product and promotional product, and the promotional scheme thereof; then, the checking module 19 proceeds to confirm if the main product of the order should have a corresponding promotional scheme thereof; and, finally, the setting module is used to select the promotional schemes and the contents thereof.

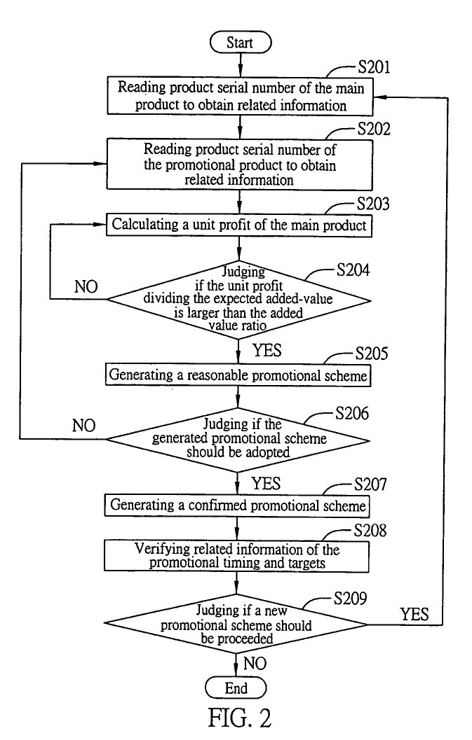

FIG. 2 provides a flow diagram showing the steps taken in executing a method for promoting product sales of the invention.

As shown in the drawing, first, in step S201, the serial number of the main product is read so as to obtain related product information for the main product. Thereafter, step S202 is followed.

In step S202, the serial number of the promotional product is read to obtain related product information of the promotional product. Thereafter, step S203 is followed.

In step S203, a Unit Profit of the main product is calculated. Thereafter, step S204 is followed.

In step S204, a determination is made as to whether the result of the Unit Profit divided by a Desired Profit is larger than a preset Floor Profit Ratio, wherein if yes, it enters into step S205; otherwise, the method returns to step S203.

In step S205, reasonable content for the promotional scheme is generated. Thereafter, step S206 is followed.

In step S206, a determination is made whether the generated promotional scheme should be adopted, wherein, if yes, step S207 is executed; otherwise, the method returns to step S202.

In step S207, a confirmation for the chosen promotional scheme is generated and stored into a database of a data processing device. Thereafter, step S208 is followed.

In step S208, related promotional information for the promotional timing and targets is verified. Thereafter, step S209 is followed.

In step S209, a determination is made as to whether a new promotional scheme should be created, wherein, if yes, the method returns to step S201; otherwise, the method terminates.

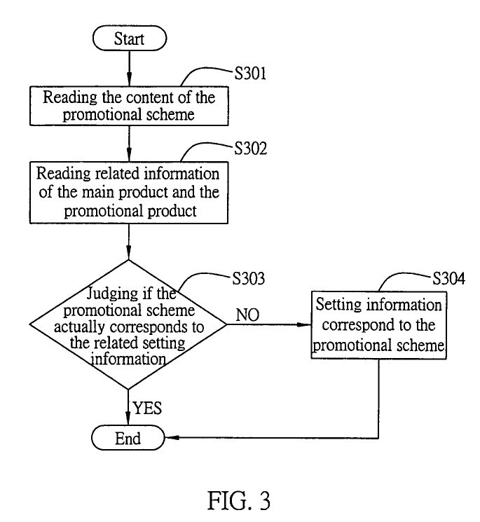

FIG. 3 illustrates detailed procedural steps involved in FIG. 2 for verifying information of suitable promotional timings and targets.

As shown in the drawing, first, in step S301, the content of a promotional scheme is read from a database of a data processing device. Thereafter, step S302 is followed.

In step S302, the related product information of the main and promotional products is read from a database of a data processing device. Thereafter, step S303 is followed.

In step S303, a determination is made as to whether the promotional scheme actually corresponds to the related setting information, including the name, time, area and/or targets, wherein, if yes, the detailed procedural step terminates; otherwise, the procedure proceeds to step S304.

In step S304, related promotional information for the promotional scheme, including the name, time, area and/or targets, etc, is set, after which, the detailed procedural step terminates.

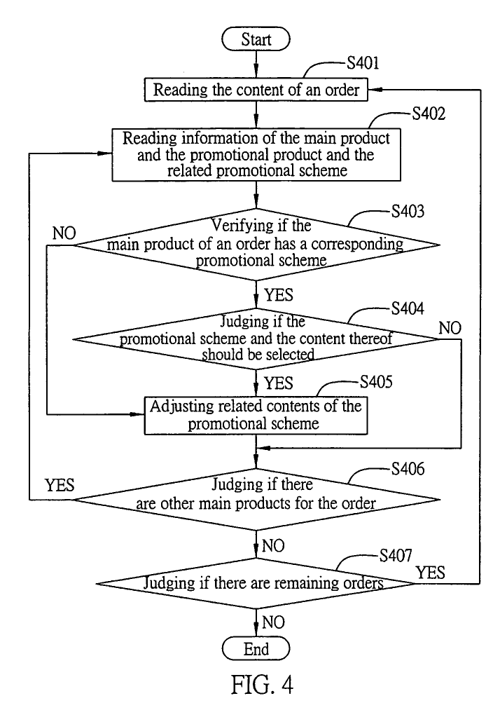

FIG. 4 illustrates the detailed procedural steps performed in another preferred embodiment for judging if a specific main product should comes with particular promotional items for a promotional scheme.

As shown in the drawing, in step S401, the content of an order is retrieved from the database. Thereafter, step S402 is followed.

In step S402, information for the main and promotional products and the related promotional schemes is retrieved from the database. Thereafter, step S403 is followed.

In step S403, a determination is made as to whether the main product of the order has a corresponding promotional scheme, wherein, if yes, step S404 is executed; otherwise, the method skips to step S405.

In step S404, a determination is made as to whether to choose the promotional scheme and the content thereof, wherein, if yes, step S405 is executed; otherwise, the method jumps to step S406.

In step S405, the content of the related promotional scheme is adjusted if necessary. Thereafter, step S406 is followed.

In step S406, a determination is made as to whether there are other main products for the order, wherein, if yes, the method returns step S402; otherwise, the method proceeds to step S407.

In step S407, a determination is made as to whether there are remaining orders, wherein, if yes, the method returns to step S401; otherwise, the method terminates.

In conclusion, the sales-promoting system and method of the present invention applicable to a data processing device have advantages over the prior art in that the invention uses a computing mechanism for calculating the Unit Profit of a main product according to the sales-related information of the main product and promotional items; provides a judging mechanism for judging the appropriateness of the content so as to come up with a reasonable promotional scheme for the product; and further provides related information of the promotional scheme for selection. In addition, the sales-promoting system and method of the present invention further provides inquiry and checking of the promotional scheme to help measure the success of a sales promotional scheme.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A system for promoting product sales applicable to a data processing device, comprising:
an accessing module for reading product information related to a main product and a promotional product;
a computing module for generating reasonable promotional schemes based on the accessed product information for the main product and promotional product and a pre-determined profit-calculation basis; and
a setting module for setting promotional information comprising at least timing and targets for conducting promotional activities, based on the promotional schemes generated by the computing module.

2. The system of claim 1, wherein the accessing module is configured to further read corresponding content of the promotional scheme in addition to the product information for the main product and the promotional product.

3. The system of claim 2, further comprising:
a judging module for use to verify if the promotional scheme actually comprises the promotional information.

4. The system of claim 1, wherein the accessing module is configured to further read related product information for orders, the corresponding main product and the promotional product thereof, and the content of the promotional scheme.

5. The system of claim 2, further comprising:
a checking module for use to determine if a main product, particularly of a received order, should come with a promotional scheme.

6. The system of claim 1, wherein the profit-calculating basis is obtained by judging whether ratio of a unit profit to a desired profit is larger than a floor profit ratio.

7. The system of claim 6, wherein the desired profit is the profit desired to be earned by a seller of the main product, and the unit profit is obtained from subtracting unit purchase prices of the main product and the promotional product from a unit selling price of the main product.

8. A method for promoting product sales applicable to a data processing device, the method comprising the steps of:
accessing product information related to a main product and a promotional product;
generating a reasonable promotional scheme according to the accessed product information and a predetermined profit-calculating basis; and
setting promotional information comprising at least timing and targets for the promotional schemes.

9. The method of claim 8, further comprising the steps of:
reading related information for the main product and the promotional product and corresponding content of the promotional scheme; and
verifying if settings for the timing and targets for the promotional schemes have been completed.

10. The method of claim 8, further comprising the steps of:
reading related information including content of an order, the main product and the promotional product thereof, and corresponding content of the promotional scheme; and
determining if a specific main product should come with a promotional item.

11. The method of claim 8, wherein the profit-calculating basis is obtained by judging if ratio of a unit profit to a desired profit is larger than a floor profit ratio.

12. The method of claim 11, wherein the desired profit is the profit desired to be earned by the sellers, and the unit profit is obtained from subtracting unit purchase prices of the main product and the promotional products from a unit selling price of the main product.
